(19) United States
(12) Patent Application Publication
(10) Pub. No.: US 2015/0267359 A1
(43) Pub. Date: Sep. 24, 2015

(54) Radiant Heating System for a Surface Structure, and Surface Structure Assembly with Radiant Heater

(71) Applicant: RTR Technologies, Inc., Stockbridge, MA (US)

(72) Inventor: Craig M. Berger, Stockbridge, MA (US)

(21) Appl. No.: 14/665,134

(22) Filed: Mar. 23, 2015

Related U.S. Application Data
(60) Provisional application No. 61/969,691, filed on Mar. 24, 2014.

(51) Int. Cl. E01C 11/26; H05B 1/02; H05B 3/26

(52) U.S. Cl. CPC E01C 11/265; H05B 3/26; H05B 1/02

(57) ABSTRACT

A surface structure assembly that is adapted to be heated when electrically connected to a source of electrical power. The assembly has a relatively flat, thin surface structure having a top surface and an opposing bottom surface, and an electrically-operated radiant heating panel that has opposed front and back surfaces and is about the same size and shape as the surface structure. A fastening system mechanically couples the front surface of heating panel to the bottom surface of the surface structure.

### CROSS-REFERENCE TO RELATED APPLICATION

This application claims priority of Provisional Patent Application Ser. No. 61/969,691 filed on Mar. 24, 2014, the entire disclosure of which is incorporated herein by reference.

### BACKGROUND

Surface structures such as tactile panels are used for many purposes, including compliance with the Americans with Disabilities (ADA) Act. Tactile panels have a series of protrusions. Snow and ice can collect on the panels and between the protrusions. This can be difficult to remove by shoveling or traditional snow-removal techniques. Snow and ice buildup can create a serious slipping hazard and can lead to injuries.

### SUMMARY

All of the elements below can be combined in any way that is technically feasible, and still remain within the scope of this disclosure.

In one aspect, a radiant heating system for surface structures is disclosed herein. In another aspect, a surface structure assembly that is adapted to be heated when electrically connected to a source of electrical power is disclosed herein.

In one example, the radiant heating system is used with a relatively flat, thin surface structure such as a tactile panel having a non-slip top surface that may or may not have a series of projections, and an opposing bottom surface. This heating system comprises an electrically-operated radiant heating panel that has opposed front and back surfaces and is about the same size and shape as the surface structure, and a fastening system that mechanically couples the front surface of heating panel to the bottom surface of the surface structure. The panels may be mounted horizontally or vertically for indoor comfort heat applications. There may be a heat reflective layer adjacent to the back surface of the heating panel, to redirect heat that escapes from the bottom of the heating panel back up through the panel and into the surface structure. There may be a ground plane placed adjacent to the top surface of the heating panel. The ground plane can be electrically connected to a ground fault interrupter so that if the surface is penetrated by a conductive object, the ground plane will be penetrated before the heating panel and trip the circuit; this is meant to help prevent electrical shocks resulting from such a penetration. A metal or some other thermally conductive material can be added to the top surface of the heater to spread heat to the edges of the panel beyond where the heater element is. A ground plane can also double as a heat spreader to provide this function.

The mechanical coupling of the heating panel to the surface structure may be indirect, such as is accomplished with epoxy between the bottom surface of the surface structure and the front surface of the heating panel. The back surface of the heating panel may be covered with a fiberglass medium or some other material to provide mechanical protection and electrical insulation. The heating panel may comprise two or more heater segments that are electrically coupled together, in series or in parallel. The heater segments may each comprise a planar electrically resistive medium and electrical busses running along opposite first and second edges of the medium. The heater segments may be located adjacent to but spaced from one another. The faces of the resistive medium may be covered with a fiberglass medium or another material that provides mechanical protection, electrical isolation and encapsulation. There may be a conduit with one end partially embedded in the fiberglass medium that covers the back surface of the heating panel, wherein the conductors that electrically connect the heating panel to a power source are fed through the conduit. There may be a device that detects temperature and that is embedded in the heater panel and comprises conductors that are also fed through the conduit.

The resistive elements may be laminated on top of one another to provide a built in back up element to increase product life. The double element in this fashion can be manufactured via a roll transfer method with a transfer adhesive between the two elements. Controls can be used to monitor the primary elements performance. If the primary element has degraded to an unsatisfactory level the control will automatically switch to the backup element and send appropriate notification.

### BRIEF DESCRIPTION OF THE DRAWINGS

Non-limiting examples of the disclosed radiant heating panel and surface structure assembly that uses the radiant heating panel are shown in the drawings, in which:

FIG. 1A is a schematic view of a radiant heating system.

FIG. 1B is a schematic cross sectional view of a surface structure assembly that is adapted to be heated by the radiant heating system.

FIG. 1C is an enlarged view of detail A of FIG. 1A.

FIG. 1D is an enlarged view of detail B of FIG. 1A.

FIG. 2A is a schematic view of a heating panel for the radiant heating system.

FIG. 2B is a similar view but that also shows the power distribution system for the heating panel.

FIG. 2C is an enlarged view of detail C of FIG. 2B.

FIGS. 3A and 3B are side and bottom views of the base fitting for the power input assembly.

FIGS. 4A and 4B are top and side views of the base plate of the fitting of FIG. 3.

FIG. 5 schematically depicts the thermistor assembly of the radiant heating system.

FIG. 6 is a schematic cross-sectional view of a heated surface structure assembly installed in a concrete structure.

FIG. 7 is a schematic illustration of an exemplary radiant heating system.

FIGS. 8A-8D show an alternative heating panel.

FIG. 9 is a partial cross-sectional view of laminated heating elements.

### DETAILED DESCRIPTION

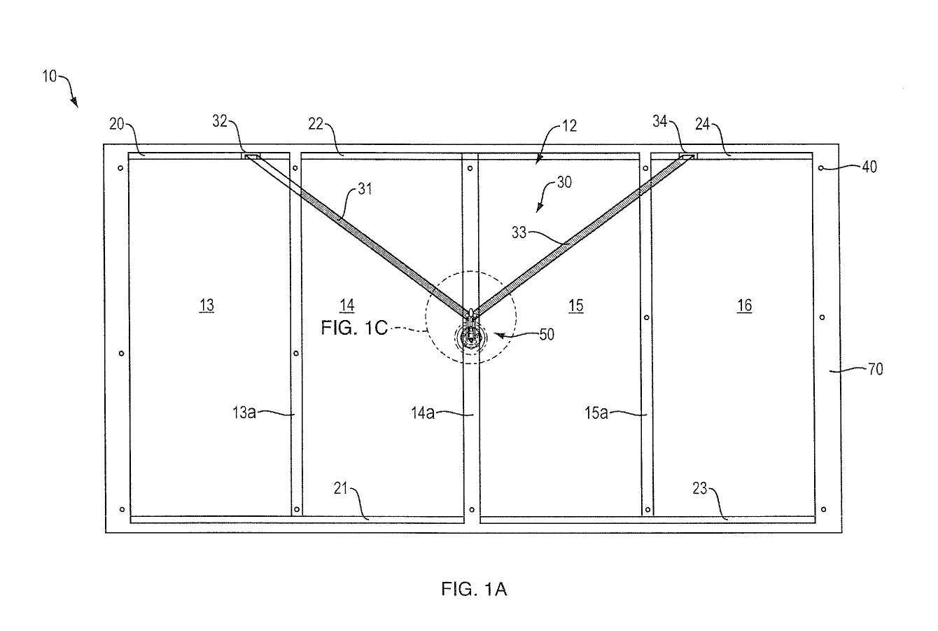

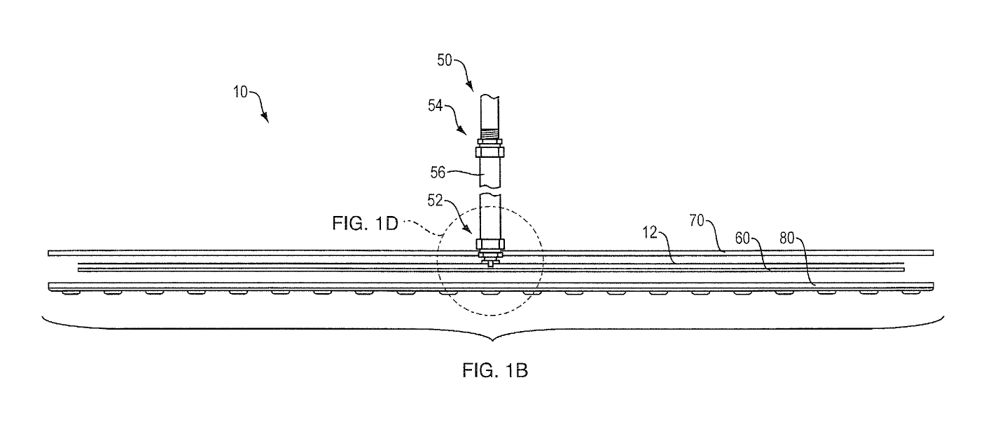

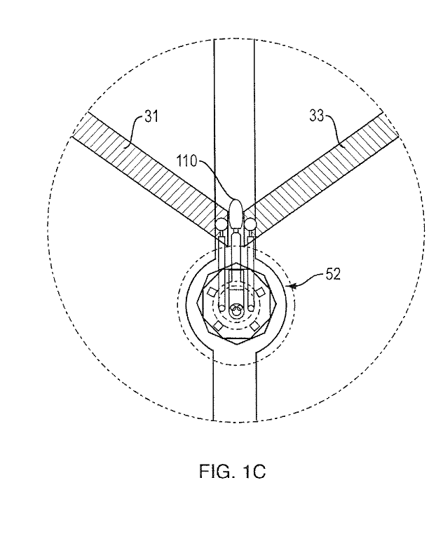

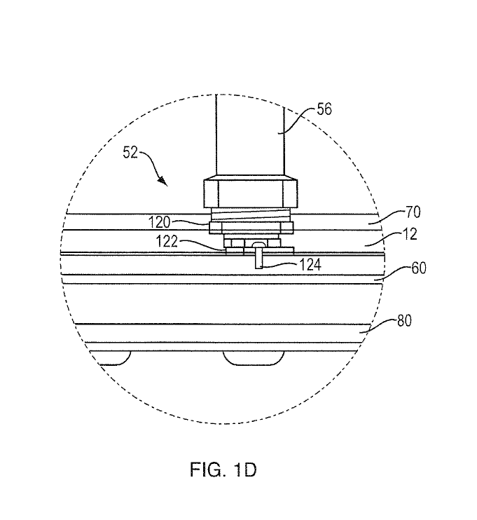

Radiant heating system 10, FIG. 1A, includes radiant heating panel 12 that has a generally rectilinear shape that closely matches the shape of a surface structure (e.g., a tactile panel) that is to be heated by heating panel 12. Heating panel 12 can be made in different shapes and sizes to match that of a surface structure it is designed to heat; there is no limitation as to the size and shape of the surface structure or that of the radiant heating panel. The radiant heating panel is constructed and arranged to heat a surface structure from its bottom surface, with the aim of melting snow and ice so as to keep the exposed surface of the surface structure free of ice and snow. The radiant heating system disclosed herein can also be used with other outdoor surfaces such as structures with non-slip top surfaces, concrete pavers, metal panels and the like.

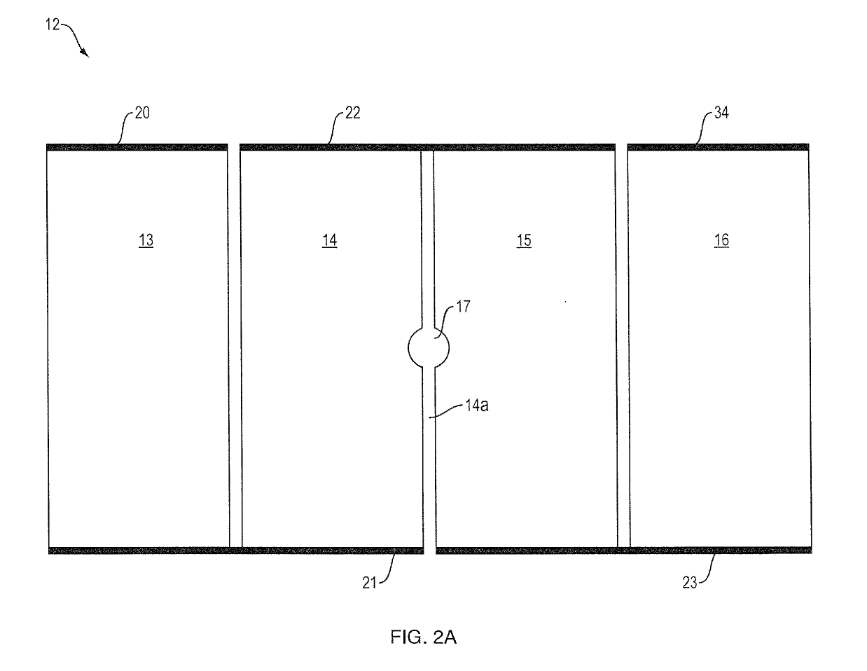

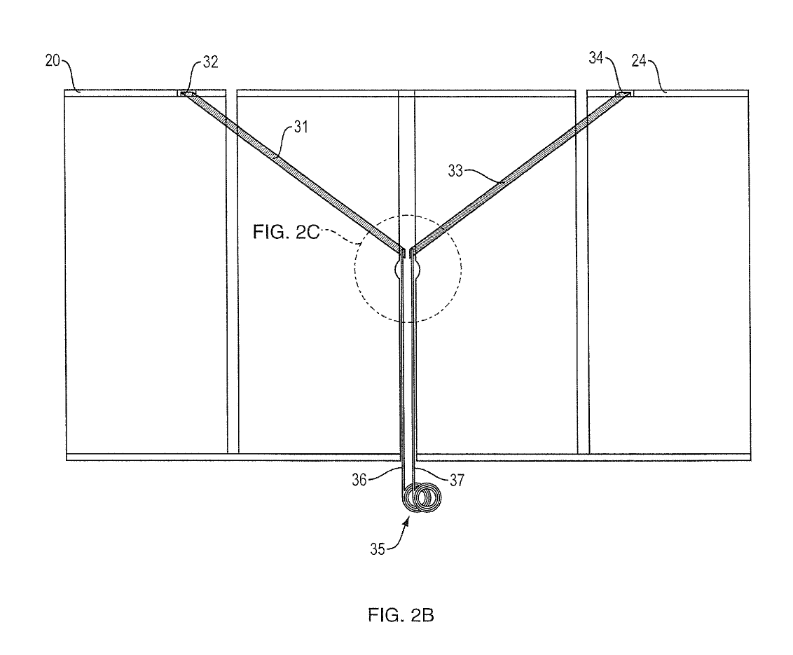

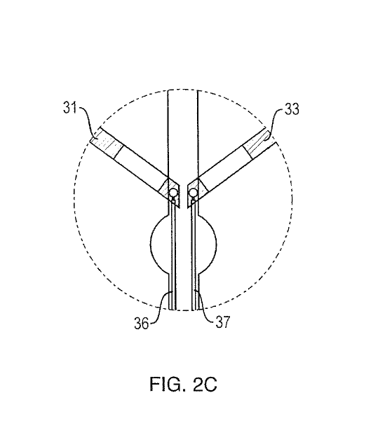

Radiant heating panel 12 functionally comprises a thin generally planar resistive sheet that is supplied with electrical energy such that the sheet radiates heat. The resistive sheet can take a desired form and design using different types of resistive heating media as is known in the field. The resistive material can have positive temperature coefficient (PTC) or negative temperature coefficient (NTC) characteristics. In one non-limiting example the resistive sheet is a carbon fiber mat that has a resistivity of about 131 ohms per square and is covered on both faces with an insulator. The heating panel may comprise one or more segments of this material. If there are two or more segments, the segments can be electrically connected in parallel and/or series. In the non-limiting example shown in the drawings, the heating panel is made from four essentially identical rectangular segments of heating media 13, 14, 15 and 16 that are separated by gaps 13a, 14a and 15a. The four segments are connected in series using a bus comprising bus segments 20-24. Power is supplied via power distribution system 30 which includes conductors 31 and 33 that are electrically connected to busses 20 and 34, respectively, via appropriate electrical connections such as can be accomplished with crimps, mechanical devices, or solder connections 32 and 34, for example. Power is fed to the heating panel from a power source and power control system, not shown, which operates at an appropriate voltage and the like for the particular heating system. Power is provided via power input leads 35 that comprise conductors 36 and 37. See FIG. 2B.

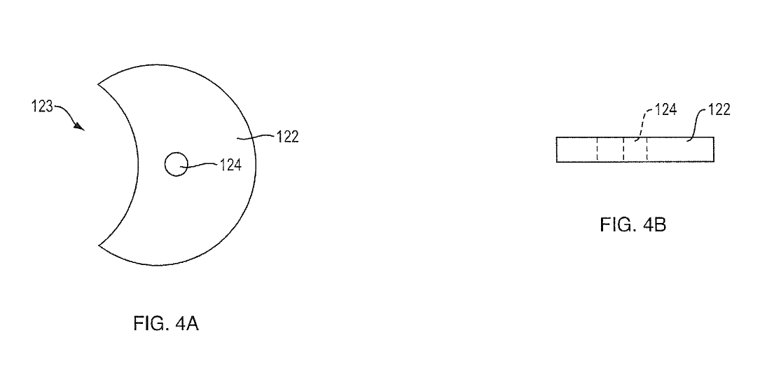

In the embodiment shown in FIGS. 1-6 of the drawings, the heating panel is fixed to the underside of surface structure 80. The fastening system 60 that mechanically couples the front surface of the heating panel to the bottom surface of the surface structure can comprise an indirect coupling such as by the use of epoxy and potentially an additional fiberglass mat between the surface structure and the heating panel. This will also help to mechanically protect and further thermally insulate the front side of the panel. Fastening system 60 may comprise an epoxy layer with thickness of about 20 mils. There may be a heat reflective layer adjacent to the back surface of the heating panel, to redirect heat that escapes from the bottom of the heating panel back up through the panel and into the surface structure. There also may be a ground plane placed adjacent to the top surface of the heating panel. The ground plane can be electrically connected to a ground fault interrupter so that if the surface is penetrated by a conductive object, the ground plane will be penetrated before the heating panel and trip the circuit; this is meant to help prevent electrical shocks resulting from such a penetration. It is also desirable to mechanically protect and further thermally insulate the rear side of the heating panel to increase energy efficiency by reducing energy loss to the environment. This may be accomplished in a desired fashion. In one non-limiting example this is accomplished using a fiberglass mat that covers the exposed rear side of the heating panel. This can be saturated with epoxy and processed using a vacuum bag so that the assembly is fully saturated with epoxy before it cures.

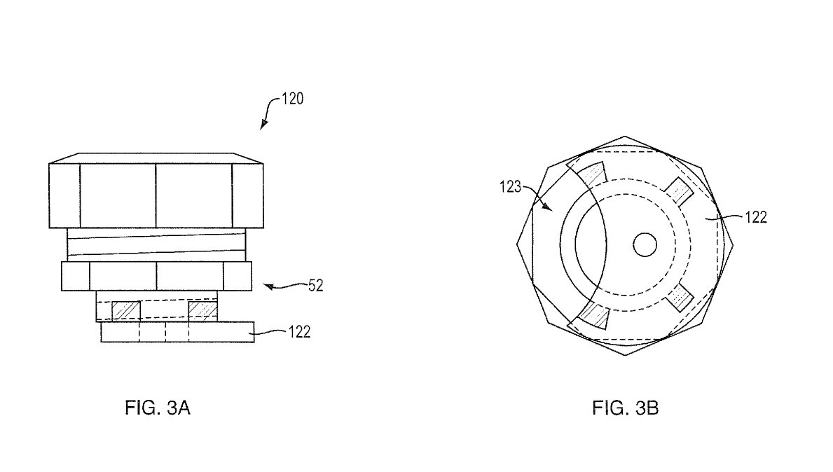

The power input leads can be coupled to the assembly in a desired fashion. In one example shown in the drawings there is a central opening 17 in gap 14a at the center of the heater. Power input assembly 50 may be used to hold the power input leads in place relative to the heater while the surface structure assembly is installed in the field. This can be accomplished with a base fitting 52, FIG. 3, which comprises fitting 120 that is welded to base plate 122 which has a cutout 123 to allow leads 36 and 37 to enter fitting 120. Base plate 122 can be screwed into the bottom of the surface structure using a self tapping screw that passes through opening 124 of plate 122 and is accepted in a pre-drilled hole in the surface structure. The epoxy layup helps to hold fitting 52 in place so that it forms a secure coupling location for the power leads.

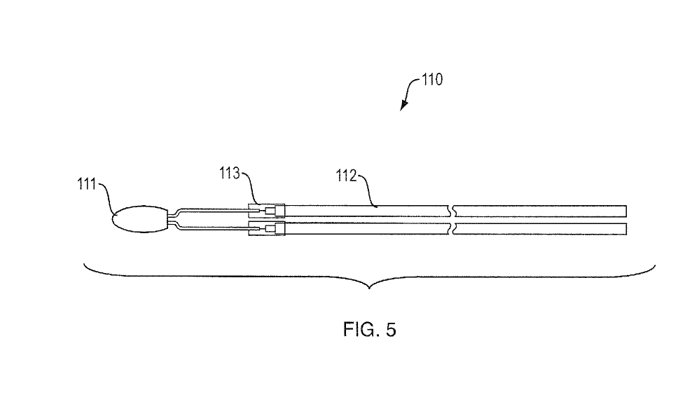

Conductors 31 and 33 are preferably flat copper conductors that are insulated, for example by wrapping them with double-sided tape or in another fashion. A temperature sensor, for example a thermistor assembly 110, is located at base fitting 52 and in gap 14a to allow sensing of temperature for purposes of power control. The temperature sensor could also be accomplished with a thermocouple or an RTD, for example. As shown in FIG. 5, thermistor assembly 110 includes thermistor 111, wires 112, and solder sleeves 113.

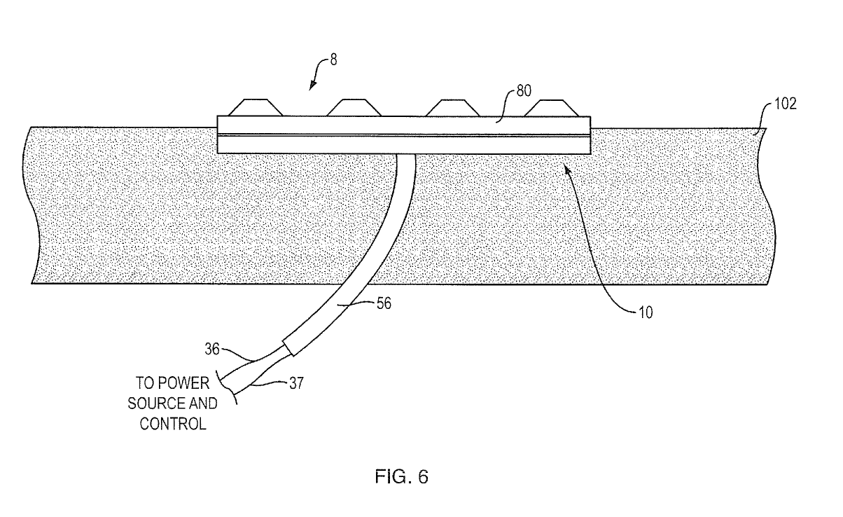

An exemplary installation of the surface structure assembly 8 in a concrete substrate 102 is shown in FIG. 6. Assembly 8 includes radiant heating system 10 coupled to the underside of surface structure 80. Conduit 56 leads from base fitting 52 of power input assembly 50 to terminal fitting 54 (not shown in FIG. 6). Surface structure assembly 8 is installed by creating a depression or cavity in the concrete and placing the assembly into the depression, typically using an appropriate adhesive system such as an epoxy or mastic. A hole is first drilled through the concrete that is large enough for conduit 56. The power input leads can then be connected to a power source and power control system that provides power sufficient to heat the surface structure so as to melt ice and snow. The control can be based on temperature and other factors as would be known to those skilled in the field. The radiant heating system panels have fifteen depressions 40, FIG. 1A, which serve as fastener location indications. The surface structure assembly is typically also bolted to the concrete by drilling through locations 40 and using appropriate fasteners that pass through the panel and are anchored in the concrete.

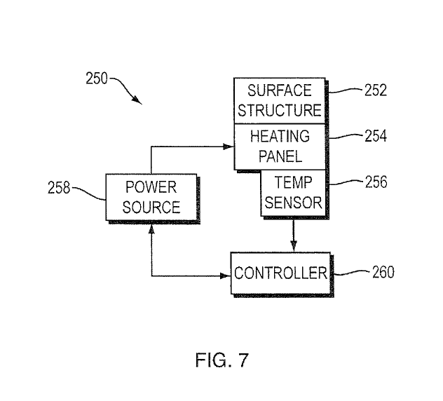

FIG. 7 is a schematic illustration of an exemplary radiant heating system 250. Heating panel 254 heats surface structure 252. Power source 258 is controlled by controller 260, which is responsive to temperature sensor 256.

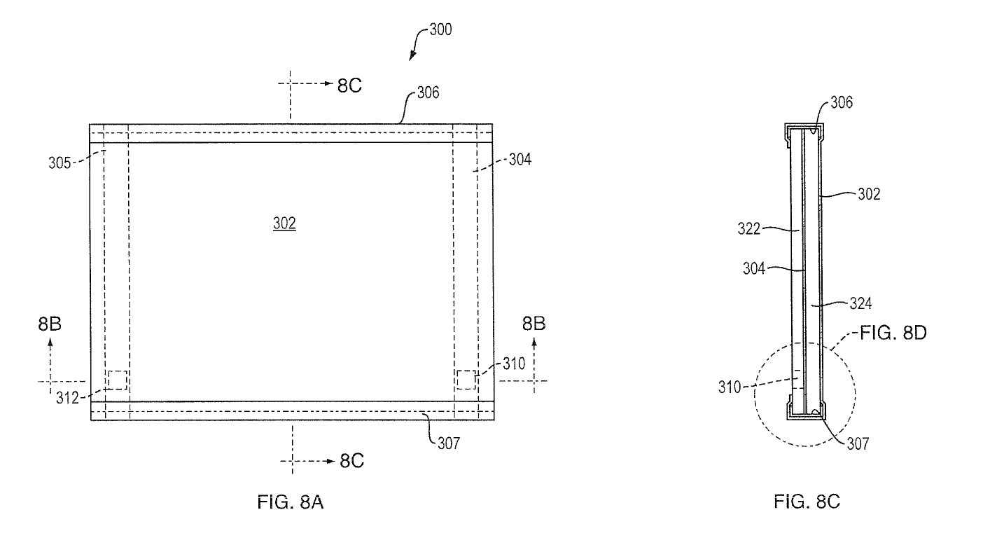

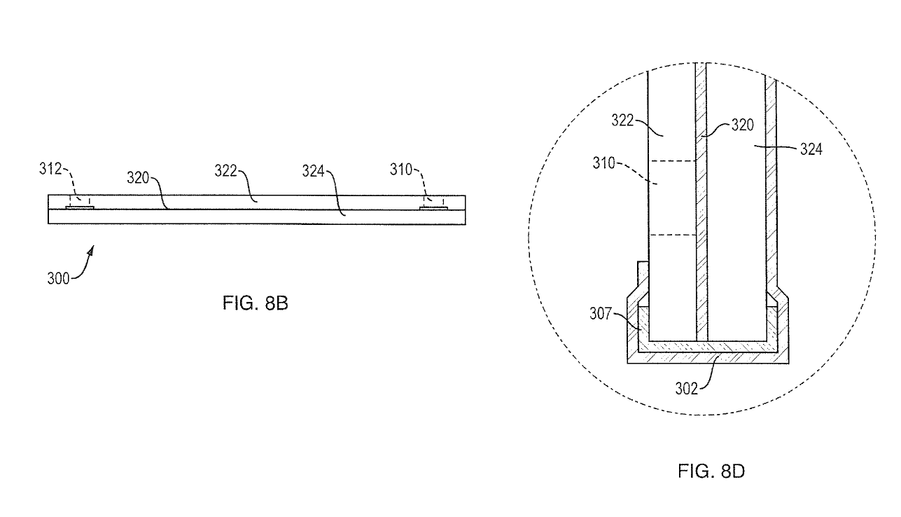

Another exemplary heating panel is shown in FIGS. 8A-8D. Heating panel 300 includes a central resistive sheet 320, which may comprise carbon fibers or be another type of conductive sheet. Power is coupled to sheet 320 by leads (not shown) that pass through openings 310 and 312 in upper insulation layer 322 which covers sheet 320. Lower electrical insulation layer 324 covers the lower face of sheet 320. Layers 322 and 324 may be prepreg material, or another material. Copper tape busses 304 and 305 are applied to the two ends of sheet 320, and act to distribute the power across the sheet; the busses need not be copper and need not be tapes. The ends of the prepreg layers outside of the busses are sealed together. The conductive sheet is exposed along the other two edges, and is covered with insulative tape 306 and 307; the tape can be Kapton™ or another insulating material. Also, the form of the insulator that seals the edges does not have to be a tape. A conductive layer 302 may be placed over the top and the taped edges. Layer 302 may be an aluminum foil layer but need not be. For example it could be another conductive metal or a conductive polymer. A purpose of layer 302 is to create a ground path should the heater be penetrated by a conductive object (such as a fastener that is mistakenly inserted into the surface being heated by panel 300). This would help to trip a circuit breaker before stray electricity could harm a person. Conductive layer 302 also helps to distribute heat into the tactile panel.

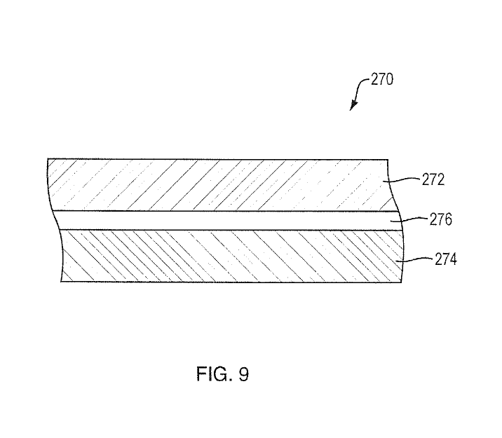

FIG. 9 is a partial cross-sectional view of laminated heating elements 270 that are part of a radiant heating panel. Two heater elements 272 and 274 are laminated one on top of the other and adjacent to the front surface of the heating panel. Adhesive layer 276 may hold elements 272 and 274 together. Resistive elements 272 and 274 can be manufactures by roll transfer method with a transfer adhesive between the two elements. One heating element can be used at a time; the second is a redundant backup that is used in case of heater failure. Controls can be used to monitor the performance of the active heating element. For example the control can measure the resistance of the heating element (e.g., by monitoring the current flow at constant voltage). If the resistance drops by an amount (e.g., 20%) based on its initial performance it could be considered to have been degraded. The system 250, FIG. 7, can then automatically switch to provide power to the other heating element.

The examples shown herein are not limiting, as the various features can potentially be accomplished in other manners that would be known to those skilled in the field. The following claims illustrate the scope of the invention herein. What is claimed is:

What is claimed is:

1. A surface structure assembly that is adapted to be heated when electrically connected to a source of electrical power, comprising:
a relatively flat, thin surface structure having a top surface and an opposing bottom surface;
an electrically-operated radiant heating panel that has opposed front and back surfaces and is about the same size and shape as the surface structure; and
a fastening system that mechanically couples the front surface of heating panel to the bottom surface of the surface structure.

2. The surface structure assembly of claim 1 wherein the mechanical coupling of the heating panel to the surface structure is indirect.

3. The surface structure assembly of claim 2 wherein the mechanical coupling of the heating panel to the surface structure is accomplished with epoxy between the bottom surface of the surface structure and the front surface of the heating panel.

4. The surface structure assembly of claim 1 wherein the back surface of the heating panel is covered with a mechanically protective and electrically insulating medium.

5. The surface structure assembly of claim 4 wherein the heating panel comprise two or more heater segments that are electrically coupled in series.

6. The surface structure assembly of claim 4 wherein the heating panel comprise two or more heater segments that are electrically coupled in parallel.

7. The surface structure assembly of claim 4 wherein the heater segments each comprise a planar electrically resistive medium and electrical busses running along opposite first and second edges of the medium.

8. The surface structure assembly of claim 7 wherein the heater segments are located adjacent to but spaced from one another.

9. The surface structure assembly of claim 8 wherein the faces of the resistive medium are covered with a mechanically protective and electrically insulating medium.

10. The surface structure assembly of claim 9 further comprising a conduit with one end partially embedded in the mechanically protective and electrically insulating medium that covers the back surface of the heating panel, wherein the conductors that electrically connect the heating panel to a power source are fed through the conduit.

11. The surface structure assembly of claim 10 further comprising a device that detects temperature and that is embedded in the heater panel and comprises conductors that are also fed through the conduit.

12. The surface structure assembly of claim 1 further comprising a ground plane located adjacent to the front surface of the heating panel.

13. The surface structure assembly of claim 1 further comprising a thermally conductive medium adjacent to the front surface of the heating panel.

14. The surface structure assembly of claim 1 further comprising a heat reflective layer located adjacent to the back surface of the heating panel.

15. The surface structure assembly of claim 1 further comprising a thermally insulating layer located adjacent to the back surface of the heating panel.

16. The surface structure assembly of claim 1 wherein the heating panel comprises a resistive sheet that comprises carbon fibers.

17. The surface structure assembly of claim 1 wherein the heating panel comprises a positive temperature coefficient (PTC) or negative temperature coefficient (NTC) material.

18. The surface structure assembly of claim 1 wherein the radiant heating panel comprises a thermally conductive medium with two heater elements laminated one on top of the other and adjacent to the front surface of the heating panel.

19. The surface structure assembly of claim 18 further comprising controls that are adapted to be used to monitor the heater elements, and wherein in the event of degraded performance of one heater element below an acceptable threshold, the controls automatically switch to the second heater element.

20. A radiant heating system for a relatively flat, thin surface structure having a top surface and an opposing bottom surface, the heating system comprising:
an electrically-operated radiant heating panel that has opposed front and back surfaces and is about the same size and shape as the surface structure; and
a fastening system that mechanically couples the front surface of heating panel to the bottom surface of the surface structure.

21. The radiant heating system of claim 20 wherein the mechanical coupling of the heating panel to the surface structure is indirect.

22. The radiant heating system of claim 21 wherein the mechanical coupling of the heating panel to the surface structure is accomplished with epoxy between the bottom surface of the surface structure and the front surface of the heating panel.

23. The radiant heating system of claim 20 wherein the back surface of the heating panel is covered with a mechanically protective and electrically insulating medium.

24. The radiant heating system of claim 23 wherein the heating panel comprise two or more heater segments that are electrically coupled in series or in parallel.

25. The radiant heating system of claim 24 wherein the heater segments each comprise a planar electrically resistive medium and electrical busses running along opposite first and second edges of the medium.

26. The radiant heating system of claim 25 wherein the heater segments are located adjacent to but spaced from one another.

27. The radiant heating system of claim 26 wherein the faces of the resistive medium are covered with a mechanically protective and electrically insulating medium.

28. The radiant heating system of claim 27 further comprising a conduit with one end partially embedded in the mechanically protective and electrical insulating medium that covers the back surface of the heating panel, wherein the conductors that electrically connect the heating panel to a power source are fed through the conduit.

29. The radiant heating system of claim 28 further comprising a device that detects temperature and that is embedded in the heater panel and comprises conductors that are also fed through the conduit.

30. The radiant heating system of claim 20 further comprising a ground plane located adjacent to the front surface of the heating panel.

31. The radiant heating system of claim 20 further comprising a thermally conductive medium adjacent to the front surface of the heating panel.

32. The radiant heating system of claim 20 further comprising a heat reflective layer located adjacent to the back surface of the heating panel.

33. The radiant heating system of claim 20 further comprising a thermally insulating layer located adjacent to the back surface of the heating panel.

34. The radiant heating system of claim 20 wherein the heating panel comprises a resistive sheet that comprises carbon fibers.

35. The radiant heating system of claim 20 wherein the heating panel comprises a positive temperature coefficient (PTC) or negative temperature coefficient (NTC) material.

36. The radiant heating system of claim 20 wherein the radiant heating panel comprises a thermally conductive medium with two heater elements laminated one on top of the other and adjacent to the front surface of the heating panel.

37. The radiant heating system of claim 36 further comprising controls that are adapted to be used to monitor the heater elements, and wherein in the event of degraded performance of one heater element below an acceptable threshold, the controls automatically switch to the second heater element.
